(19) United States
(12) Patent Application Publication
(10) Pub. No.: US 2025/0111557 A1
(43) Pub. Date: Apr. 3, 2025

(54) Secure Content Layer for Sensor Hardware

(71) Applicant: Apple Inc., Cupertino, CA (US)

(72) Inventors: Mahesh B Chappalli, San Jose, CA (US); Clement Moussu, San Francisco, CA (US)

(21) Appl. No.: 18/895,203

(22) Filed: Sep. 24, 2024

Related U.S. Application Data
(60) Provisional application No. 63/541,212, filed on Sep. 28, 2023.

(51) Int. Cl. G06T 11/00; G06T 11/60

(52) U.S. Cl. CPC G06T 11/001; G06T 11/60

(57) ABSTRACT

An electronic device having image processing circuitry to securely display secure content is provided. The image processing circuitry may include first image processing circuitry to process first image data in a first execution environment. The image processing circuitry may also include second image processing circuitry to process second image data in a second execution environment. The second execution environment may be a trusted execution environment to generate composite image data based on blending the processed first image data with the processed second image data such that the processed second image is always visible.

### CROSS-REFERENCE TO RELATED APPLICATIONS

This application claims priority to U.S. Application No. 63/541,212, filed Sep. 28, 2023, entitled “Secure Content Layer for Sensor Hardware,” which is incorporated by reference herein in its entirety for all purposes.

### BACKGROUND

This disclosure relates to image processing circuitry to insert an indicator into image content when a sensor of a device is active or recently active even in the event of a software malfunction.

People desire to trust that the electronic sensors of their electronic devices will not be used without their permission or awareness. As such, some electronic devices display special indicators in image content to indicate visually when a sensor, such as a camera or microphone, is currently or was recently in use. That is, the displayed frame may include secure (e.g. trusted) content for privacy-oriented purposes, such as a camera indication light (CIL) or a microphone indication light (MIL). This allows the person using the device to be aware when those sensors have been activated. As such, the secure or trusted content must be guaranteed to be presented to the user as intended. However, because these indicators are part of the image content, it is possible that a malfunction in the software that generates image content could result in the indicators not appearing in the image content, even if the sensors are activated.

### SUMMARY

Embodiments herein are directed to secure exclave architecture for image processing circuitry. The image processing circuitry may include a display pipeline that includes a secure content layer. The image processing circuitry, via the secure content layer as well as other image processing blocks located in the display pipeline, may insert an indicator into image content when a sensor is currently or was recently in use. In this way, a potential attack surface is reduced and the image content may include the indicator even in the event of a software malfunction. The image processing circuitry may insert the indicator itself in response to a signal directly from the sensor or due to the activation of the sensor. Because the secure content layer is part of a trusted execution environment, the electronic display may display the indicator even in the event of a malfunction.

The image processing circuitry may include both non-secure and secure circuitry. The non-secure parts of the image processing circuitry may include display pipeline blocks that prepare frames of image data for presentation on an electronic display of an electronic device using various image processing operations. The display pipeline may provide a variety of adjustments to the image data via a series of image processing blocks. For example, image data may undergo color management including tone mapping, transforms, blending, processing through a three-dimensional (3D) color lookup table (3D CLUT), gamut mapping, gamma transforms, and so forth. Further image data adjustments may include pixel contrast control and local tone mapping, white point adjustment, chromatic correction, and application of a display border mask to provide a proper shape of the image data. Other blocks of the display pipeline may address present conditions of the electronic display, such as temperature and ambient light, but also pixel burn-in (e.g., pixel age), and the like.

The secure content layer components of the display pipeline may include a secure blend unit, a secure extractor, and a secure direct memory access (DMA) engine. In other embodiments, the DMA engine may not be considered as part of the display pipeline. In some embodiments, the secure content layer may be all or partially included in the display pipeline and may, therefore, include some or all of the image processing “blocks.” In this way, image processing circuitry described herein may allow for physical isolation of distributed trusted data by providing a separate data paths controlled from a secure environment by one or more processes in order to enable the display pipeline to perform tasks associated with both untrusted processes and trusted processes. As discussed in more detail below, the exclave architecture described herein provides a way for a trusted processes to have pixel data combined with input pixel data from an untrusted process.

The secure content layer may be provided as a single layer that may include many secure non-overlapping destination regions, such as a fetch region, a convert region, a DeGamma LUT region, and a 3×3 Transform region. Additionally, the secure content layer may include a separate secure blend point with secure blend modes executed in a trust environment of the image processing circuitry to ensure that the secure content, when blended into normal content, remain visible under various conditions (e.g., similar background content, low light). Further, the secure content layer may be located in a secure region of the image processing circuitry that is separate from the normal content regions, or non-secure regions. The secure region may include certain blocks relating to secure content (e.g., indicators to indicate a secure operation is taking place, indicators to indicate that a sensor is collecting private information). In this way, the blocks relating to secure content may be controlled in a trusted execution environment, while most other blocks of the display pipeline continue to run in a rich, or non-trusted, execution environment.

The secure image data may be blended into image data after the image data has undergone at least some, but not all, of the processing in the non-trusted blocks of the display pipeline. This may reduce the attack surface in the display pipeline to undesirably obscure the secure content. The secure content may be blended into the display pipeline for final processing through the non-secure portions of the display pipeline to adjust the image data based on conditions of the electronic display, among other things.

### BRIEF DESCRIPTION OF THE DRAWINGS

Various aspects of this disclosure may be better understood upon reading the following detailed description and upon reference to the drawings in which:

FIG. 1 is a schematic diagram of an electronic device that includes an electronic display, in accordance with an embodiment;

FIG. 2 is an example of the electronic device of FIG. 1 in the form of a handheld device, in accordance with an embodiment;

FIG. 3 is another example of the electronic device of FIG. 1 in the form of a tablet device, in accordance with an embodiment;

FIG. 4 is another example of the electronic device of FIG. 1 in the form of a computer, in accordance with an embodiment;

FIG. 5 is another example of the electronic device of FIG. 1 in the form of a watch, in accordance with an embodiment;

FIG. 6 is another example of the electronic device of FIG. 1 in the form of a computer, in accordance with an embodiment;

FIG. 7 is a schematic diagram of the secure content being displayed on an electronic device when certain sensors are active, in accordance with an embodiment;

FIG. 8 is a block diagram of the image processing circuitry, in accordance with an embodiment;

FIG. 9 is a block diagram of the trusted and non-trusted aspects of the image processing circuitry, in accordance with an embodiment;

FIG. 10 is a flowchart of an example process for displaying the secure content indicator, in accordance with an embodiment;

FIG. 11 is a block diagram of the secure blend mode options, in accordance with an embodiment;

FIG. 12 is a schematic diagram of an example of preventing the secure content from being hidden via a secure blend mode, in accordance with an embodiment; and

FIG. 13 is a schematic diagram of an example of preventing the secure content from being hidden via another secure blend mode, in accordance with an embodiment.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

Electronic devices may use specialized hardware sometimes referred to as “enclaves” that may use physical separation techniques to create a secure environment and prevent external entities (e.g., executing processes, the CPU, etc.) from being able to directly access internal data. A secure environment may be confined to a particular region of a device that can be controlled and does not extend to other regions outside of that control. However, a secure environment may be extended by implementing secure exclaves. As described in more detail below, a computing device may include one or more processors configured to co-execute trusted processes and untrusted processes in an isolated manner such that the trusted processes may provide checks on the untrusted processes.

For example, electronic devices often use electronic displays to present visual information, including a special indicator to visually indicate when a sensor of the electronic device is or was recently in use. Such electronic devices may include any device with a display and one or more sensors, such as a microphone or camera. For example, such devices may include computers, mobile phones, portable media devices, tablets, televisions, virtual-reality headsets, and vehicle dashboards, among many others. Visual indicators that signal to a user of the electronic device that a sensor of the device is active may serve as a security measure in that the user may be made aware of when the electronic device is collecting visual or audio data from the user via a microphone or camera, for instance. The image processing circuitry of the electronic device may include both trusted and non-trusted execution environments. The secure circuitry of the image processing circuitry may be located in the trusted execution environment and may insert the indicator into image content of the display to ensure that the indicator is always shown, even when there is a software malfunction, thereby improving the security of the electronic device.

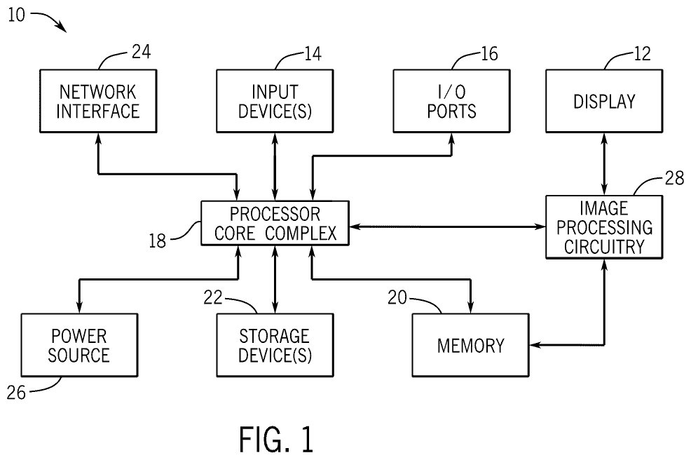

With the foregoing in mind, FIG. 1 is an example electronic device 10 with an electronic display 12 that may display a secure indicator when a sensor is operating. As described in more detail below, the electronic device 10 may be any suitable electronic device, such as a computer, a mobile phone, a portable media device, a tablet, a television, a virtual-reality headset, a wearable device such as a watch, a vehicle dashboard, or the like. Thus, it should be noted that FIG. 1 is merely one example of a particular implementation and is intended to illustrate the types of components that may be present in an electronic device 10.

The electronic device 10 may include one or more electronic displays 12, input devices 14, input/output (I/O) ports 16, a processor core complex 18 having one or more processors or processor cores, local memory 20, a main memory storage device 22, a network interface 24, a power source 26, and image processing circuitry 28. The various components described in FIG. 1 may include hardware elements (e.g., circuitry), software elements (e.g., a tangible, non-transitory computer-readable medium storing instructions), or a combination of both hardware and software elements. As should be appreciated, the various components may be combined into fewer components or separated into additional components. For example, the local memory 20 and the main memory storage device 22 may be included in a single component. Moreover, the image processing circuitry 28 (e.g., a graphics processing unit, a display image processing pipeline, etc.) may be included in the processor core complex 18 or be implemented separately.

The processor core complex 18 is operably coupled with local memory 20 and the main memory storage device 22. Thus, the processor core complex 18 may execute instructions stored in local memory 20 or the main memory storage device 22 to perform operations, such as generating or transmitting image data to display on the electronic display 12. As such, the processor core complex 18 may include one or more general purpose microprocessors, one or more application specific integrated circuits (ASICs), one or more field programmable logic arrays (FPGAs), or any combination thereof.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a BLUETOOTH® network, a local area network (LAN), such as an 802.11x Wi-Fi network, or a wide area network (WAN), such as a 4G, Long-Term Evolution (LTE), or 5G cellular network.

The power source 26 may provide electrical power to operate the processor core complex 18 and/or other components in the electronic device 10. Thus, the power source 26 may include any suitable source of energy, such as a rechargeable lithium polymer (Li-poly) battery and/or an alternating current (AC) power converter.

The I/O ports 16 may enable the electronic device 10 to interface with various other electronic devices. The input devices 14 may enable a user to interact with the electronic device 10. For example, the input devices 14 may include buttons, keyboards, mice, trackpads, and the like. Additionally or alternatively, the electronic display 12 may include touch sensing components that enable user inputs to the electronic device 10 by detecting occurrence and/or position of an object touching its screen (e.g., surface of the electronic display 12).

The electronic display 12 may display a graphical user interface (GUI) (e.g., of an operating system or computer program), an application interface, text, a still image, and/or video content. The electronic display 12 may include a display panel with one or more display pixels to facilitate displaying images. Additionally, each display pixel may represent one of the sub-pixels that control the luminance of a color component (e.g., red, green, or blue). As used herein, each display pixel corresponds to one sub-pixel (e.g., a red, green, or blue subpixel).

As described above, the electronic display 12 may display an image by controlling the luminance output (e.g., light emission) of the sub-pixels based on corresponding image data. In some embodiments, pixel or image data may be generated by or received from an image source, such as the processor core complex 18, a graphics processing unit (GPU), storage device 22, or an image sensor (e.g., camera). Additionally, in some embodiments, image data may be received from another electronic device 10, for example, via the network interface 24 and/or an I/O port 16. Moreover, in some embodiments, the electronic device 10 may include multiple electronic displays 12 and/or may perform image processing (e.g., via the image processing circuitry 28) for one or more external electronic displays 12, such as connected via the network interface 24 and/or the I/O ports 16.

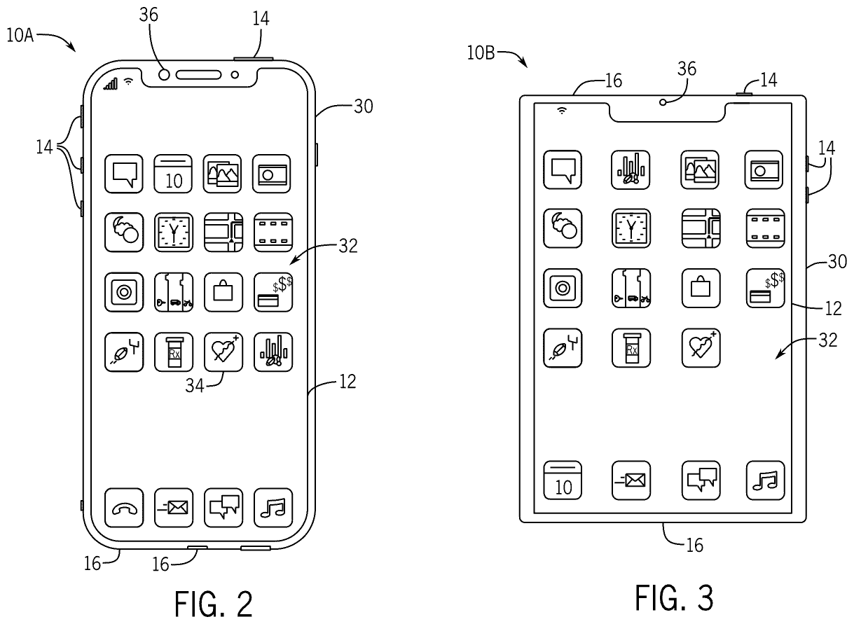

The electronic device 10 may be any suitable electronic device. To help illustrate, one example of a suitable electronic device 10, specifically a handheld device 10A, is shown in FIG. 2. In some embodiments, the handheld device 10A may be a portable phone, a media player, a personal data organizer, a handheld game platform, and/or the like. For illustrative purposes, the handheld device 10A may be a smartphone, such as an IPHONE® model available from Apple Inc.

The handheld device 10A may include an enclosure 30 (e.g., housing) to, for example, protect interior components from physical damage and/or shield them from electromagnetic interference. The enclosure 30 may surround, at least partially, the electronic display 12. In the depicted embodiment, the electronic display 12 is displaying a graphical user interface (GUI) 32 having an array of icons 34. By way of example, when an icon 34 is selected either by an input device 14 or a touch-sensing component of the electronic display 12, an application program may launch.

Input devices 14 may be accessed through openings in the enclosure 30. Moreover, the input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, and/or toggle between vibrate and ring modes. Moreover, the I/O ports 16 may also open through the enclosure 30. Additionally, the electronic device may include one or more cameras 36 to capture pictures or video. In some embodiments, a camera 36 may be used in conjunction with a virtual reality or augmented reality visualization on the electronic display 12.

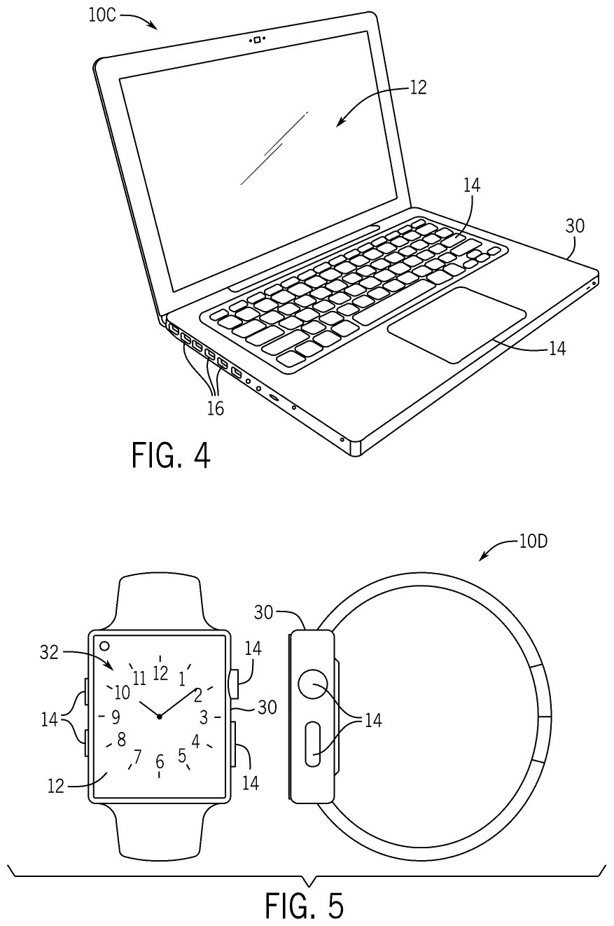

Another example of a suitable electronic device 10, specifically a tablet device 10B, is shown in FIG. 3. For illustration purposes, the tablet device 10B may be any IPAD® model available from Apple Inc. A further example of a suitable electronic device 10, specifically a computer 10C, is shown in FIG. 4. For illustrative purposes, the computer 10C may be a MACBOOK® or IMAC® model available from Apple Inc. Another example of a suitable electronic device 10, specifically a watch 10D, is shown in FIG. 5. For illustrative purposes, the watch 10D may be an APPLE WATCH® model available from Apple Inc. As depicted, the tablet device 10B, the computer 10C, and the watch 10D each also includes an electronic display 12, input devices 14, I/O ports 16, and an enclosure 30. The electronic display 12 may display a GUI 32. Here, the GUI 32 shows a visualization of a clock. When the visualization is selected either by the input device 14 or a touch-sensing component of the electronic display 12, an application program may launch, such as to transition the GUI 32 to presenting the icons discussed in FIGS. 2 and 3.

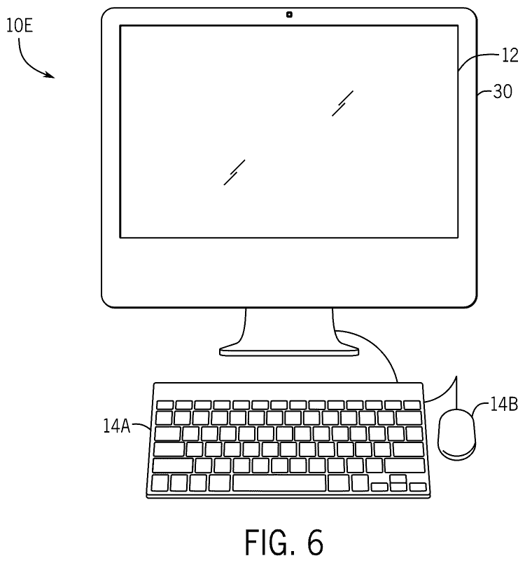

Turning to FIG. 6, a computer 10E may represent another embodiment of the electronic device 10 of FIG. 1. The computer 10E may be any suitable computer, such as a desktop computer, a server, or a notebook computer, but may also be a standalone media player or video gaming machine. By way of example, the computer 10E may be an IMAC®, a MACBOOK®, or other similar device by Apple Inc. of Cupertino, California. It should be noted that the computer 10E may also represent a personal computer (PC) by another manufacturer. A similar enclosure 30 may be provided to protect and enclose internal components of the computer 10E, such as the electronic display 12. In certain embodiments, a user of the computer 10E may interact with the computer 10E using various peripheral input devices 14, such as a keyboard 14A or mouse 14B, which may connect to the computer 10E.

As described above, the electronic display 12 may display images based at least in part on image data. Before being used to display a corresponding image on the electronic display 12, the image data may be processed, for example, via image processing circuitry, as described in further detail below.

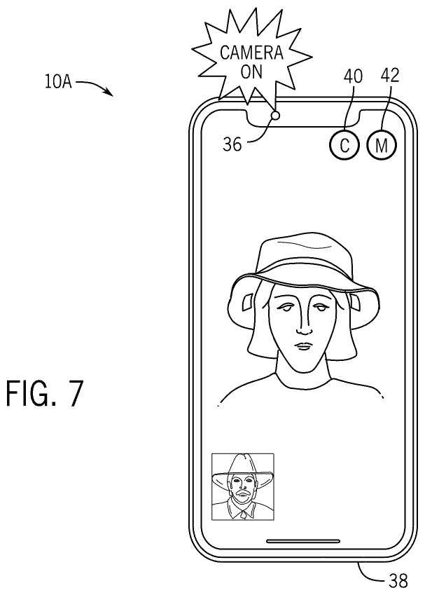

To help illustrate how secure content indicators may be displayed on the electronic display when certain sensors (e.g., camera, microphone) are on, FIG. 7 shows, for example, a handheld device 10A with a display 12 and an audio sensor or transducer (e.g. a microphone) 38. As shown in FIG. 7, the handheld device 10A may be used to conduct a videoconference in which the camera 36 and the audio sensor or transducer 38 are activated and in use. In that case, secure content may be displayed on the electronic display 12 of the handheld device 10A to indicate to the user of the device that certain sensors are in use. For example, a camera indicator light (CIL) (a secure indicator associated with the camera 40), and/or a microphone indicator light (MIL) (a secure indicator associated with the audio sensor or microphone 42), may be displayed at the top of the screen in response to the camera 36 and the audio sensor 38 being used. That is, the secure indicators 40, 42 may be inserted when one or more sensors and/or applications of a device are activated or communicate with image processing circuitry, as described in more detail below. In this way, both the secure content indicator and the non-secure content (e.g. the videoconference) are both displayed on the electronic display 12 simultaneously.

In FIG. 7, the secure content indicators 40, 42 are shown to appear as a dot on the electronic display 12; however, it should be noted that the secure content may be any suitable type of indicator fetched from memory. That is, the secure content may appear in a variety of colors or shapes, including text. For example, the secure content indicator associated with the camera 40 may include the words “CAMERA ON”, just the letter “C”, a colored dot, the outline of a dot, a star, an icon of a camera, or any combination thereof. Further, the secure content may appear in a fixed position on the electronic display 12 or it may move around the display. Additionally, although FIG. 7 features an example of the secure content indicators being applied in a videoconference, it should be noted that the secure content indicators may be applied in any instance in which a sensor of a device 10 is in use, and therefore collecting private or secure content such as audio or visual data. As such, the secure content may be applied to any private or secure function of the device that a user may want to be alerted about when such functions, or sensors used for such functions, are active and/or in use. For example, a user may want secure content indicators applied when using gyroscope sensors, WiFi, Face ID or facial recognition, digital payment or personal finance applications, location-tracking or navigation applications, or other sensors or applications that may collect, request, or track private or secure data.

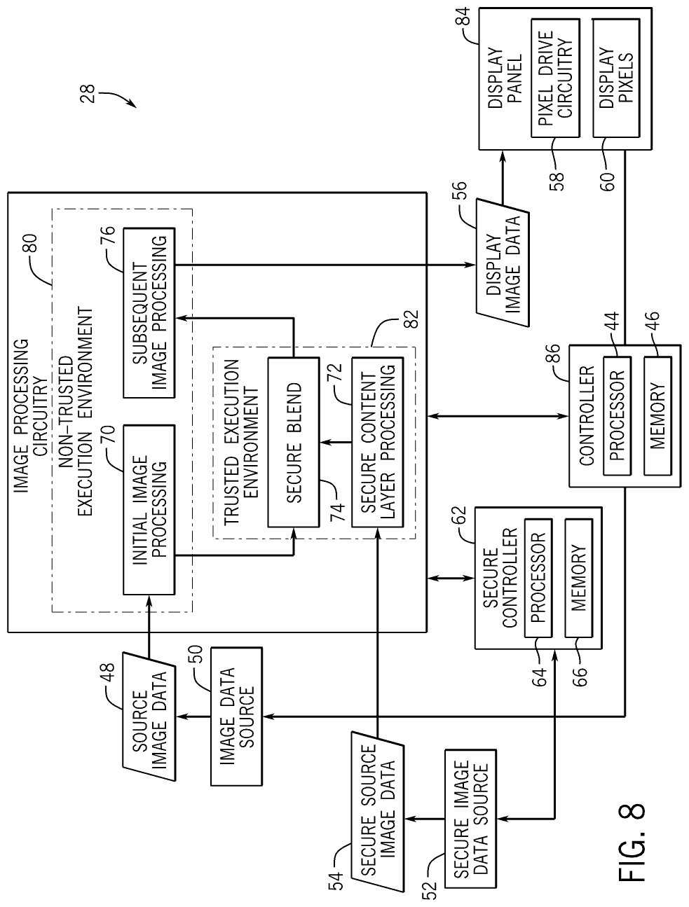

As mentioned above, display of the secure content while a sensor is or was recently in use must be guaranteed in order to provide the intended security benefit of the indicator. This may be achieved via the image processing circuitry of the device. That is, the secure content data may be fetched and inserted by image processing circuitry 28, as shown in FIG. 8. The image processing circuitry 28 may process image data, including both the non-secure image data (e.g. image data other than the secure content indicator) and the secure image data (e.g., the secure content indicator), for display on one or more electronic displays 12. The image processing circuitry 28 may be implemented in the electronic device 10, in the electronic display 12, or a combination thereof. For example, the image processing circuitry 28 may be included in the processor core complex 18, a timing controller (TCON) in the electronic display 12, or any combination thereof. As should be appreciated, although image processing is discussed herein as being performed via a number of image data processing blocks, embodiments may include hardware and/or software components to carry out the techniques discussed herein. For example, the image processing circuitry 28 may include a display pipeline and additional hardware or software means for processing image data. Image data may be processed via the display pipeline of the image processing circuitry 28 to reduce or eliminate image artifacts, compensate for one or more different software or hardware related effects, and/or format the image data for display on one or more electronic displays 12.

The electronic device 10 may also include an image data source 50, a secure image data source 52, a display panel 84, a controller 86, and/or a secure controller 62. The controller 86 and the secure controller 62 may be in communication with the image processing circuitry 28. In some embodiments, the display panel 84 of the electronic display 12 may be a self-emissive display (e.g., organic light-emitting-diode (OLED) display, micro-LED display, etc.), a transmissive display (e.g., liquid crystal display (LCD)), or any other suitable type of display panel 84. In some embodiments, the controller 86 and/or secure controller 62 may control operation of the image processing circuitry 28, the image data source 50, the secure image data source 52, and/or the display panel 84. To facilitate controlling operation, the controller 86 may include a controller processor 44 and/or controller memory 46. Similarly, to facilitate controlling operation of the secure controller 62, the secure controller 62 may also include a secure controller processor 64 and/or secure controller memory 66. In some embodiments, the controller processor 44 and/or the secure controller processor 64 may be included in the processor core complex 18, the image processing circuitry 28, a timing controller in the electronic display 12, a separate processing module, or any combination thereof. The controller processor 44 may execute instructions stored in the controller memory 46, while the secure controller processor 64 may execute instructions in the secure controller memory 66. Additionally, in some embodiments, the controller memory 46 and/or the secure controller memory 66 may be included in the local memory 20, the main memory storage device 22, a separate tangible, non-transitory, computer-readable medium, or any combination thereof.

The image processing circuitry 28 may receive source image data 48 corresponding to a desired image to be displayed on the electronic display 12 from the image data source 50. The source image data 48 may include non-secure image data, or any image data to be displayed that does not include the secure content indicator (e.g., secure source image data 54). The source image data 48 may indicate target characteristics (e.g., pixel data) corresponding to the desired image using any suitable source format, such as an RGB format, an αRGB format, a YCbCr format, and/or the like. Moreover, the source image data may be fixed or floating point and be of any suitable bit-depth. Furthermore, the source image data 48 may reside in a linear color space, a gamma-corrected color space, or any other suitable color space. Additionally, the image processing circuitry 28 may receive secure source image data 54 corresponding to a secure content indicator to be displayed on the electronic display 12 from the secure image data source 52. Like the source image data 48, the secure source image data 54 may indicate target characteristics (e.g., pixel data) corresponding to the desired image (e.g. secure content indicator) using any suitable source format, such as an RGB format, an αRGB format, a YCbCr format, and/or the like. Moreover, like the source image data 48, the secure source image data 54 may be a fixed or floating point and be of any suitable bit-depth. Furthermore, the secure source image data 54 may reside in a linear color space, a gamma-corrected color space, or any other suitable color space. Moreover, as used herein, pixel data/values of image data may refer to individual color component (e.g., red, green, and blue) data values corresponding to pixel positions of the display panel.

As described above, the image processing circuitry 28 may operate to process source image data 48 and secure source image data 54 received from the image data source 50 and the secure image data source 52, respectively. As previously discussed, the image data source 50 may include any and all image data to be displayed that is not the secure source image data 54 (e.g., the secure content indicator). The source image data 48 may include captured images (e.g., from one or more cameras 36), images stored in memory, graphics generated by the processor core complex 18, or a combination thereof. The secure source image data 54 may include images stored in the secure controller memory 66. For example, the secure image data source 52 may include dedicated direct memory access (DMA) memory of the secure controller 62.

The functions (e.g., operations) performed by the image processing circuitry 28 may be divided between various image data processing blocks (e.g., circuitry, modules, or processing stages) that are part of the display pipeline described above. The term “block”, as used herein, may or may not mean a logical or physical separation between the image data processing blocks. Such image data processing blocks may include one or more burn-in compensation (BIC)/burn-in statistics (BIS) blocks, a pixel contrast control (PCC) block, color management block, a dither block, a blend block, a warp block, a scaling/rotation block, etc. Such image data processing blocks may receive and process the source image data 48 and output display image data 56 in a format (e.g., digital format, image space, and/or resolution) interpretable by the display panel 84. Simultaneously, but separately, the image processing circuitry 28 may also receive and process the secure source image data 54 and output the secure content indicator in a format interpretable by the display panel 84. After processing, the image processing circuitry 28 may output the display image data 56, which may include both the secure content indicator and the non-secure image data, to the display panel 84.

Based at least in part on the display image data 56, analog electrical signals may be provided, via pixel drive circuitry 58, to display pixels 60 of the display panel 84 to illuminate the display pixels 60 at a desired luminance level and display a corresponding image.

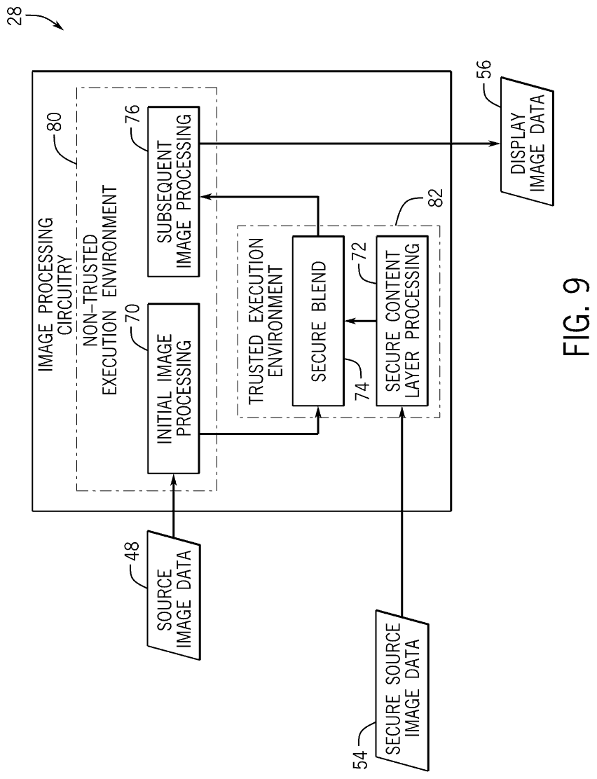

Turning now to FIG. 9, FIG. 9 illustrates an overall arrangement of the secure and non-secure aspects of the image processing circuitry 28. As discussed above with regards to FIG. 8, the source image data 48, which may include non-secure image data, or any image data to be displayed that does not include the secure content indicator (e.g., secure source image data 54), may undergo initial image processing 70 via various processing blocks located in a non-trusted execution environment 80 of the image processing circuitry 28. The initial image processing 70 may occur in software, hardware, or both, whereas the secure content layer processing 72 occurs only in hardware to reduce attack surface. It should be noted that only vetted software may have access to a hardware trusted execution environment 82. Examples of the initial image processing 70 include color management including tone mapping, transforms, blending, processing through a three-dimensional (3D) color lookup table (3D CLUT), gamut mapping, gamma transforms, and so forth. The initial image processing 70 may also include pixel contrast control and local tone mapping, white point adjustment, chromatic correction, and application of a display border mask to provide a proper shape of the image data.

Simultaneous with the initial image processing 70 of the source image data 48, the secure source image data 54 may be fetched by dedicated DMA to undergo secure content layer processing 72 in the hardware trusted execution environment 82. It should be noted that only vetted software may have access to the DMA in the trusted execution environment 82. The secure source image data 54 may then be blended via the secure blend block 74. It should be noted that the secure blend block 74 is located in the trusted execution environment 82, which occurs only in hardware to reduce attack surface. Further, both the secure content layer processing block 72 and the secure blending block 74 may be controlled by the secure controller 62. Blending is performed in a linear space and may include one or more blending modes that are independently configurable, as described in more detail below.

Also blended at the secure blend block 74 is the source image data 48 after initial image processing 70. That is, the source image data 48 and the secure source image data 54 are both blended at the same time in the secure blend block 74. As such, the secure blend 74 includes both the secure content indicator generated via the secure source image data 54 as well as the non-secure image data generated via the source image data 48. The blended secure and non-secure data are then sent for subsequent image processing 76 in the rich, or non-trusted, execution environment 80. The subsequent image processing 76 may include other blocks of the display pipeline to address present conditions of the electronic display, such as temperature and ambient light, but also pixel burn-in (e.g., pixel age), and the like. By way of example, these blocks may include sub-pixel layout resampling or compensation to account for the particular sub-pixel layout of the electronic display; arbitrary border gain to reduce image artifacts due to a shape of the electronic display (e.g., to compensate image data to avoid artifacts due to curves of the edges of the electronic display); peak luminance control to reduce the brightness of some of the image data to ensure the electronic display does not consume too much energy at any single instant; frame-delayed current control to gradually reduce the brightness of some of the image data over time to avoid image artifacts in peak luminance control; burn-in compensation to adjust the image data to appear uniform in spite of aging effects of the display pixels of the electronic display, as well as statistics collection relating to burn-in; pixel temperature uniformity compensation to adjust the image data to account for the temperature on different parts of the electronic display; white point correction to adjust the white point of the image data based on the ambient light around the electronic display; panel response correction to map image data from an ideal gamma space to an actual gamma space found in the electronic display; pixel drive compensation to avoid motion blur artifacts due to gray-to-gray transient response of some display panels; and common voltage (VCOM) uniformity correction to adjust image data for nonuniformity (e.g., fluctuations) across common voltage electrodes of the electronic display. The display image data 56, which contains both the secure and non-secure image data, may then be displayed via the electronic display.

Referring now to FIG. 10, FIG. 10 illustrates a flow diagram of an example process 220 for displaying the secure content indicator. In some embodiments, the non-secure content and the secure content may be generated separately (process blocks 222, 224). It should be noted that, although not shown in FIG. 10, the generated content may be store separately as well. The image processing circuitry 28 may then perform initial image processing on the non-secure content (processing block 226) in a rich, or non-trusted, execution environment. The secure content may be fetched and then blended with the initially processed non-secure content such that the final blended content include both the secure content and the non-secure content (processing block 228). It should be noted that blending the secure and non-secure content may occur in a trusted execution environment. Subsequent image processing may be performed on the blended content (processing block 230). Subsequent image processing may include image processing relating to a present condition of the electronic display, such as those discussed above. The blended and subsequently processed image may then be output for display on the electronic display (processing block 232).

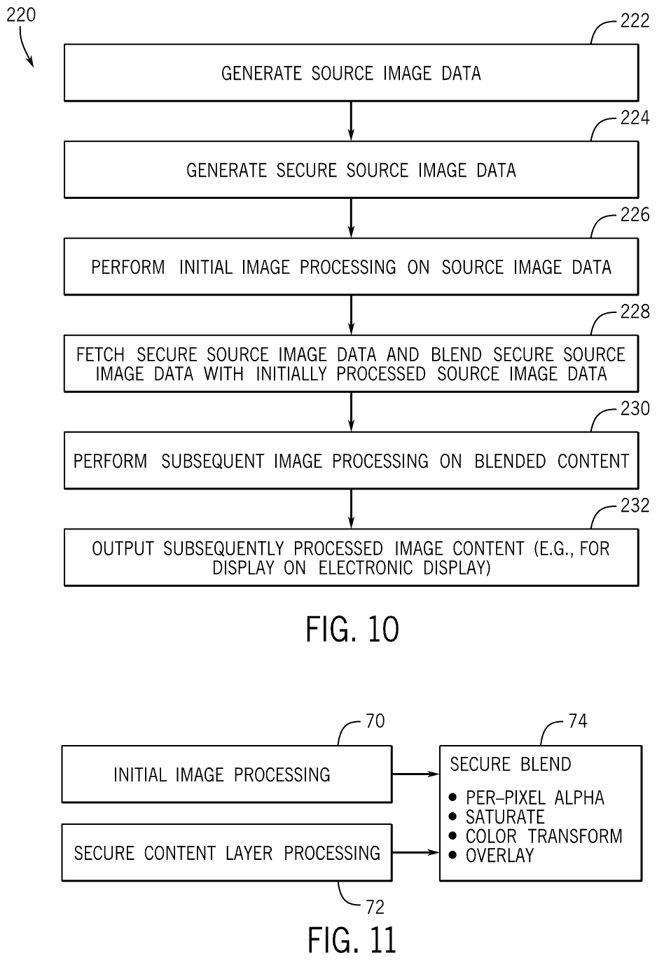

Referring now to FIG. 11, FIG. 11 represents the secure blending block 74 and the various secure blend modes. Initial image processing 70 occurs in the rich, non-trusted execution environment 80, while the secure content layer processing 72 and the secure blend occur in the trusted execution environment 82. That is, the output of the initial image processing 70 (e.g., the intermediate image data) and the output of the secure content layer processing 72 (e.g., the secure content indicator) converge at the secure blend block 74 of the secure content layer, or trusted execution environment 82. The secure blend block 74 may blend each of the secure content regions at defined coordinates in linear space on top of the output from a display border mask (DBM) block. That is, blending of the secure content and the non-secure content is not performed or controlled in software running in a non-trusted computing environment. In this way, the secure blend block 74 ensures that the secure content always appears on top of the display image data 56. It should be noted that pixel gains may be independently programmed for the output of DBM and each of the four enabled regions. For pixel locations that do not belong to any of the enabled secure content regions, the output of DBM may pass through with only the corresponding gain applied. However, pixel gain on the output of DBM may not be applied when all the four regions are disabled. That is, disabling all the four regions may effectively turn off the secure blend functionality. Blending modes may be independently configurable per enabled region so long as the mode is not disabled for an enabled region.

The secure blend block 74 may include one or more blending modes performed in hardware as described above. For example, as shown in FIG. 11, the secure blend block 74 may include a normal blend mode, a saturate blend mode, a color transform blend mode, an overlay blend mode, or any number of other blend modes suitable for displaying the secure content indicator. As used herein, the term “normal” blend mode may refer to a blend mode of per-pixel alpha value combined with dissolve and limits. As used herein, the term “saturate” may refer to a blend mode that overrides per-pixel alpha with saturate alpha value and combines with dissolved and limits. The “color transform” blend mode, as used herein, may refer to a blend mode that applies a color transform through a 4×5 matrix (M) to derive R, G, and B alpha values and combine with dissolve and limits. Further, as used herein, the term “overlay” may refer to a blend mode that stretches contrast based on R, G, and B values of secure content and uses per-pixel alpha values combined with dissolve and limits. The color transform and overlay blend modes are described in more detail below.

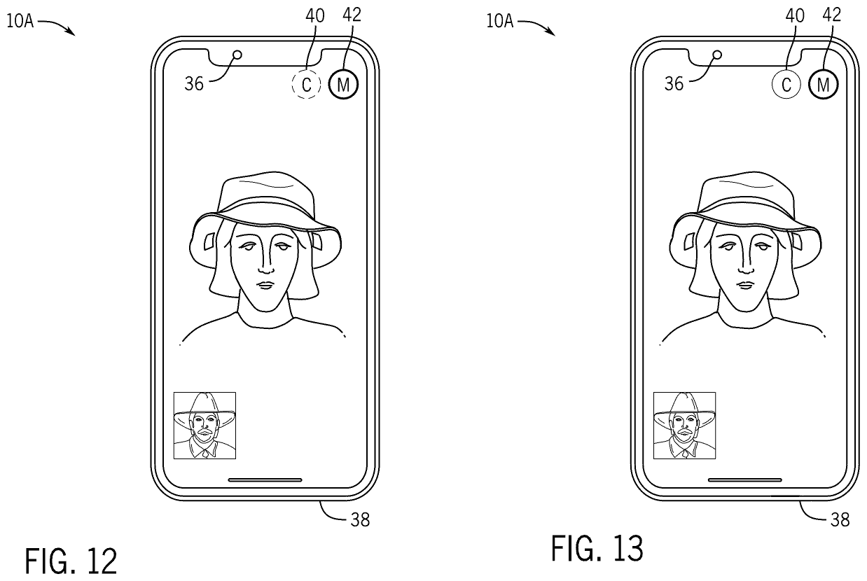

Turning now to FIGS. 12 and 13, FIGS. 12 and 13 illustrate an example of how the overlay and color transform blend modes may be useful to prevent the secure content from being hidden when mixed into the intermediate image data from the initial image processing blocks. For example, as shown in FIG. 12, during a video conference on a handheld device 10A, the camera 36 and audio sensors (e.g., microphone) 38 may be on and activated; however, the background of the display, or the intermediate image data from the initial image processing blocks, match the camera secure content indicator 40 such that the camera secure content indicator 40 is hidden from view. Alternatively, the camera secure content indicator 40 may be hidden from view due to an attack on the initial image processing software 70. In that case, even though the camera 36 may be on and activated during the conference call, the secure content indicator for the camera 36 is not “on” or is hidden from view. That is, the camera 36 may be collecting video information without the user's knowledge.

To prevent the case where a user's background is a similar color as the indicator, or other situations where the secure content indicator may be hidden from view, the overlay and color transform secure blend modes may be useful. As shown in FIG. 13, the camera secure indicator 40 may be blended for contrast via either the overlay or color transform blend modes. That is, the secure content indicator for the camera 40 and the intermediate image generated from the source image data 48 may be securely blended in hardware via the secure blend block 74 located in the trusted execution environment 82 to produce a composite image such that the secure content is visually distinctive from the intermediate image. For example, using the color transform blend mode, the secure blend block 74 may change the color of the indicator to one or more values that are outside a color range of the intermediate data. In this way, the secure content may be blended to contrast the color of the background (e.g., the intermediate image) on the handheld device 10A so that the camera secure content indicator 40 is visible on the screen.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. Image processing circuitry comprising:
a first image processing circuitry configured to process first image data in a first execution environment;
a second image processing circuitry configured to process second image data in a second execution environment, wherein the second execution environment is a trusted execution environment configured to generate composite image data based on the processed first image data and the processed second image data; and
third image processing circuitry configured to further process the composite image data in the first execution environment.

2. The image processing circuitry of claim 1, wherein the first image processing circuitry is configured to perform image processing related to color management.

3. The image processing circuitry of claim 2, wherein the image processing related to color management comprises tone mapping, transformation, blending, processing using a three-dimensional (3D) color lookup table (3D CLUT), gamut mapping, gamma transformation, pixel contrast control, white point adjustment, chromatic correction, or application of a display border mask, or any combination thereof.

4. The image processing circuitry of claim 1, wherein the second image data comprises an indicator that a sensor is in use, and wherein the second image processing circuitry is configured to fetch and blend the indicator into the first image data.

5. The image processing circuitry of claim 1, wherein the second image processing circuitry comprises a secure blend block comprising overlay or color transform blend modes.

6. The image processing circuitry of claim 1, wherein the third image processing circuitry is configured to adjust the composite image data based on present conditions of an electronic display.

7. The image processing circuitry of claim 1, wherein the third image processing circuitry comprises sub-pixel layout resampling or compensation, arbitrary border gain, peak luminance control, frame-delayed current control, burn-in compensation, white point correction, panel response correction, pixel drive compensation, or common voltage (VCOM) uniformity correction, or any combination thereof.

8. An electronic device comprising:
an electronic display comprising:
display pixels configured to display an image; and
image processing circuitry communicatively coupled to the electronic display and configured to generate the image, wherein the image processing circuitry comprises:
first image processing circuitry configured to process first image data; and
second image processing circuitry configured to process second image data and generate the image based on the processed first image data and the processed second image data, wherein the second image processing circuitry is located in a trusted execution environment.

9. The electronic device of claim 8, wherein the first image processing circuitry is located in a rich execution environment.

10. The electronic device of claim 8, wherein the first image processing circuitry comprises circuitry configured to perform tone mapping, transformation, blending, processing using a three-dimensional (3D) color lookup table (3D CLUT), gamut mapping, gamma transformation, pixel contrast control, white point adjustment, chromatic correction, or application of a display border mask, or any combination thereof.

11. The electronic device of claim 8, wherein the image processing circuitry comprises third image processing circuitry coupled to the second image processing circuitry and configured to perform subsequent image processing on the image prior to display.

12. The electronic device of claim 11, wherein the third image processing circuitry is located in a rich execution environment.

13. The electronic device of claim 11, wherein the third image processing circuitry is configured to adjust the image based on present conditions of the electronic display.

14. The electronic device of claim 13, wherein the present conditions of the electronic display comprise a sub-pixel layout, a temperature, pixel age, or panel characteristics, or any combination thereof.

15. The electronic device of claim 8, wherein the second image processing circuitry is configured to generate the image based on the processed first image data and the processed second image data via blending the processed first image data with the processed second image data such that the processed second image data is always visible.

16. A method for displaying secure content on a user device, comprising:
fetching, via first image processing circuitry controlled by a non-trusted execution environment, a first source image;
performing, via the first image processing circuitry, initial image processing on the first source image to generate an intermediate image;
fetching, via second image processing circuitry controlled by a trusted execution environment, a second source image;
performing, via the second image processing circuitry, image processing to generate a secure content image;
blending, via the second image processing circuitry, the secure content image and the intermediate image to generate a composite image based on the secure content image and the intermediate image;
performing, via third image processing circuitry, subsequent image processing on the composite image; and
displaying, via the third image processing circuitry, the composite image on an electronic display of the user device.

17. The method of claim 16, wherein the second source image is fetched from secure memory.

18. The method of claim 16, wherein the initial image processing comprises image processing related to color management not specific to the electronic display.

19. The method of claim 16, wherein the third image processing circuitry is controlled by the non-trusted execution environment.

20. The method of claim 16, wherein blending the secure content image and the intermediate image comprises using a color transform blend mode, an overlay blend mode, or both.

21. The method of claim 20, wherein the color transform blend mode is configured to blend the secure content image with the intermediate image to preserve visibility of the secure content image when blended with the intermediate image regardless of the intermediate image to produce the composite image.
